(19) United States
(12) Patent Application Publication
(10) Pub. No.: US 2014/0095792 A1
(43) Pub. Date: Apr. 3, 2014

(54) CACHE CONTROL DEVICE AND PIPELINE CONTROL METHOD

(71) Applicant: FUJITSU LIMITED, Kawasaki-shi (JP)

(72) Inventors: Makoto HATAIDA, Yokohama (JP); Takaharu ISHIZUKA, Kawasaki (JP); TAKASHI YAMAMOTO, Kawasaki (JP); Yuka HOSOKAWA, Ota (JP)

(73) Assignee: FUJITSU LIMITED, Kawasaki-shi (JP)

(21) Appl. No.: 14/097,306

(22) Filed: Dec. 5, 2013

Related U.S. Application Data
(63) Continuation of application No. PCT/JP2011/064980, filed on Jun. 29, 2011.

(51) Int. Cl. G06F 12/08

(52) U.S. Cl. CPC G06F 12/0811
USPC 711/122

(57) ABSTRACT

A cache control device includes an entering unit, a first searching unit, a reading unit, a second searching unit, and a rewriting unit. The entering unit alternately enters, into a pipeline, a load request for reading a directory received from a processor and a store request for rewriting a directory received from the processor. When the first searching unit determines that the directory targeted by the load request is present in the first cache memory or the second cache memory, the reading unit reads the directory from the cache memory in which the directory is present. When the second searching unit determines that the directory targeted by the store request is present in the first cache memory, the rewriting unit rewrites the directory that is stored in the first cache memory.

### CROSS-REFERENCE TO RELATED APPLICATION

This application is a continuation of International Application No. PCT/JP2011/064980, filed on Jun. 29, 2011, and designated the U.S., the entire contents of which are incorporated herein by reference.

### FIELD

The embodiments discussed herein are related to a cache control device and a pipeline control method.

### BACKGROUND

In a related computer system, multiple central processing units (CPUs) may sometimes share their main storage. Furthermore, to speed up processes, each CPU retains, in its cache memory, a part of the data or a program stored in the main storage. When multiple CPUs that share the main storage retain caches, there is a problem in that data in different caches is inconsistent.

Because of this, in a computer system, the consistency of data in different caches is maintained, for example, by using a directory that is a tag that retains information related to the state of each block in the main storage.

Furthermore, a CPU reads a directory retained in a cache and specifies data to be read. When the data is updated, the CPU rewrites the directory. In general, a large-capacity cache random access memory (RAM) is a single port RAM that executes either reading or writing of data in one cycle.

Consequently, for example, the computer system divides the time at which pieces of data is entered into pipelines into pieces and then alternately controls the reading and writing of the cache RAM. Then, the computer system uses the write cycle of the cache RAM for only updating the directory and then enters load requests and store requests into pipelines in a read cycle without distinguishing the load requests and the store requests. Hereinafter, the action of the reading and the writing performed by a cache RAM is referred to as “read/write” and the operation of the reading and the writing performed by a directory is referred to as “load/store”.

As described above, a cache control device easily controls the entering of load requests and store requests into pipelines; however, the load requests and the store requests are entered into pipelines in only a read cycle in the cache RAM. Consequently, the throughput becomes half of that compared with a case in which requests are entered into pipelines in both the read cycle and the write cycle. Consequently, there is a known method, which is as a technology that improves the throughput, in which caches are constructed in multi levels.

In the following, a related technology that improves the throughput by constructing caches in multi levels will be described with reference to FIG. 11. FIG. 11 is a schematic diagram illustrating a related technology that improves the throughput by constructing caches in multi levels. As illustrated in FIG. 11, this technology includes a 2-port RAM (hereinafter, referred to as a “high-speed cache memory 801”), whose capacity is small but can simultaneously read and write data at high speed in one cycle, and a single port RAM (hereinafter, referred to as a “low-speed cache memory 802”), which has been described above. A cache control device receives, in both a read cycle and a write cycle, a load request and a store request, enters the requests into a pipeline, and simultaneously searches the high-speed cache memory 801 and the low-speed cache memory 802.

For example, when the cache control device receives a load request from a routing controller 804, the cache control device simultaneously searches the high-speed cache memory 801 and the low-speed cache memory 802 (Steps S901 and S902). If a directory is present in the high-speed cache memory 801, the cache control device reads the directory from the high-speed cache memory 801 and then outputs the directory to the routing controller 804 (Step S903).

Furthermore, if no directory is present in the high-speed cache memory 801, the cache control device reads a directory from the low-speed cache memory 802 or a main storage 803 (Steps S904 and S905) and then outputs the directory to the routing controller 804 (Step S906). As described above, the throughput is improved because a request is always entered into a pipeline instead of being entered only in the read cycle of the cache RAM.

Furthermore, when the cache control device receives a store request, the cache control device updates the directory that was read from, for example, the high-speed cache memory 801 and then writes the directory back again to the high-speed cache memory 801 (Step S907).

If, for example, no directory is present in the high-speed cache memory 801, the cache control device stores, in the high-speed cache memory 801, the directory that was read from the low-speed cache memory 802 or the main storage 803 (Step S908). Furthermore, if no free entry is present in the high-speed cache memory 801, the cache control device selects an entry in the high-speed cache memory 801 (Step S909) and executes the replacement in which the selected entry is moved to the low-speed cache memory 802 (Step S910). Accordingly, the cache control device includes a buffer 805 for the replacement under the assumption that the replacement is consecutively performed.
Patent Document 1: Japanese Laid-open Patent Publication No. 2010-170292

However, with the related technology described above, when the replacement is performed, it is not possible to suppress the reduction in throughput.

For example, in the low-speed cache memory 802, because only one of writing and reading is performed in one cycle, when replacement is performed by the cache control device, a load request or a store request conflicts with the replacement process. Consequently, the cache control device performs the replacement after the cache control device blocks the load request or the store request from entering into a pipeline.

Specifically, the cache control device blocks a load request or a store request from entering into the pipeline every time the cache control device performs a replacement. Consequently, if the cache control device often performs a replacement, the blocking of a load request or a store request entering into a pipeline increases; therefore, the throughput may sometimes not be improved.

### SUMMARY

According to an aspect of an embodiment, a cache control device includes an entering unit, a first searching unit, a reading unit, a second searching unit, and a rewriting unit. The entering unit alternately enters into a pipeline, a load request for reading a directory that is received from a processor and a store request for rewriting a directory that is received from the processor. The first searching unit receives the load request that is entered by the entering unit, that searches a second cache memory and a first cache memory in which the speed of reading and writing data is higher than the speed of reading and writing data in the second cache memory, and that determines whether a directory targeted by the load request is present. The reading unit reads, when the first searching unit determines that the directory targeted by the load request is present in the first cache memory or the second cache memory, the directory from the cache memory in which the directory is present. The second searching unit receives the store request that is entered by the entering unit, that searches the first cache memory, and that determines whether a directory targeted by the store request is present. The rewriting unit rewrites, when the second searching unit determines that the directory is present in the first cache memory, the directory in the first cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of a computer system that includes a cache control device according to a first embodiment;

FIG. 2 is a block diagram illustrating the configuration of the cache control device;

FIG. 3 is a schematic diagram illustrating the operation of a process performed by the cache control device when a load request is received;

FIG. 4 is a schematic diagram illustrating the operation of a process performed by the cache control device when a store request is received;

FIG. 5 is a flowchart illustrating the flow of a process performed by the cache control device when a load request is received;

FIG. 6 is a flowchart illustrating the flow of a process performed by the cache control device when a store request is received;

FIG. 7 is a timing chart illustrating a state in which requests are entered into pipelines performed by a cache control device according to a related technology;

FIG. 8 is another timing chart illustrating a state in which requests are entered into pipelines performed by a cache control device according to the related technology;

FIG. 9 is a timing chart illustrating a state in which requests are entered into pipelines performed by a cache control device according to the first embodiment;

FIG. 10 is another timing chart illustrating a state in which requests are entered into pipelines performed by the cache control device according to the first embodiment; and

FIG. 11 is a schematic diagram illustrating a related technology that improves the throughput by constructing caches in multi levels.

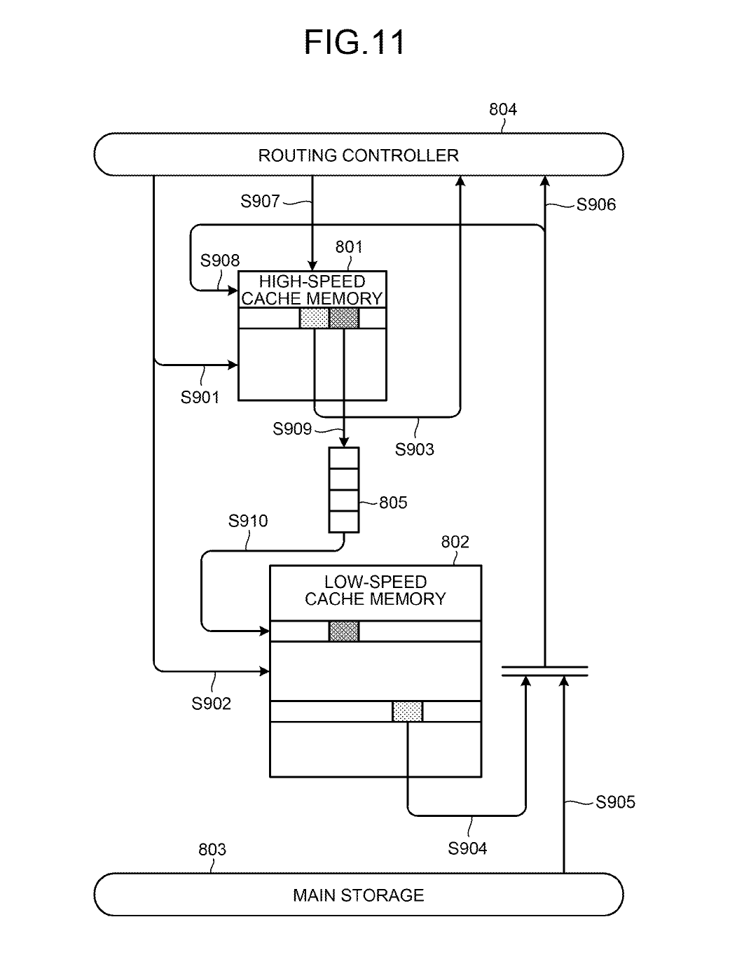

### DESCRIPTION OF EMBODIMENTS

Preferred embodiments of the present invention will be explained with reference to accompanying drawings. The present invention is not limited to the embodiments. Furthermore, the embodiments can be appropriately used in combination as long as the processes do not conflict with each other.

### [a] First Embodiment

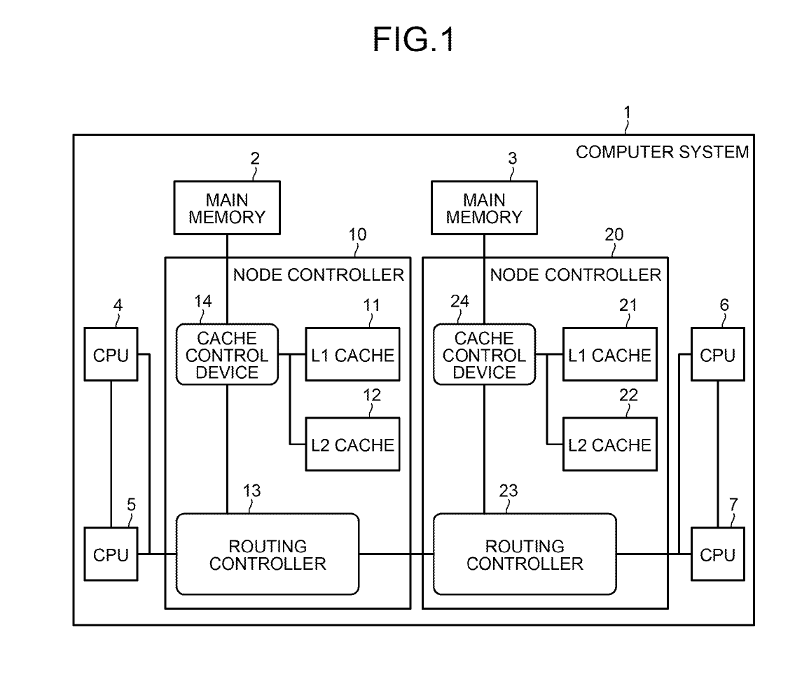

In a first embodiment, the configuration, the operation, the flow of a process, and the advantage of a computer system that includes the cache control device according to the first embodiment will be described with reference to FIGS. 1 to 10.

Configuration of the computer system that includes the cache control device according to the first embodiment

FIG. 1 is a block diagram illustrating the configuration of a computer system that includes a cache control device according to a first embodiment. As illustrated in FIG. 1, a computer system 1 includes a main memory 2, a main memory 3, a central processing unit (CPU) 4, a CPU 5, a CPU 6, a CPU 7, a node controller 10, and a node controller 20. The number of CPUs or memories included in the computer system 1 is only an example and is not limited thereto.

The main memories 2 and 3 are storage devices that temporarily store therein pieces of data or programs that are used by the CPUs 4 to 7. The main memory 2 is, for example, a dynamic random access memory (DRAM). The CPUs 4 to 7 are arithmetic units that perform various calculations.

The node controller 10 is a control device that controls, in accordance with requests from the CPUs 4 and 5, an input and an output of data between the main memory 2 and an L1 cache 11 or an L2 cache 12. The node controller 10 includes the Level 1 (L1) cache 11, the Level 2 (L2) cache 12, a routing controller 13, and a cache control device 14.

The L1 cache 11 is a cache memory that is shared by the CPU 4 and the CPU 5 and that temporarily stores therein data that is frequently used from among pieces of data or directories stored in the main memory 2 or 3. The L1 cache 11 is, for example, a static random access memory (SRAM). The speed of reading and writing data in the L1 cache 11 is higher than the speed of reading and writing data in the L2 cache 12, which will be described later; however, the storage capacity is small. The directory mentioned here records the state of each block in the main memory 2 or 3. For example, the directory includes information indicating which cache memory retains a copy of the target block or information indicating whether the cache has been written to.

The L2 cache 12 is a cache memory that is shared by the CPU 4 and the CPU 5 and that temporarily stores therein data that is frequently used from among pieces of data or directories stored in the main memory 2 or 3. The L2 cache 12 is, for example, an SRAM. The storage capacity of the L2 cache 12 is greater than the storage capacity of the L1 cache 11; however, the speed of reading and writing data is low.

Furthermore, the L1 cache 11 and the L2 cache 12 are not used in a hierarchical manner. Specifically, from among pieces of data or directories stored in the main memory 2, data or directories that are used most recently are stored in the L1 cache 11 and the data or directories that are not used by the L1 cache 11 any more are stored in the L2 cache 12.

The routing controller 13 controls, in accordance with requests from the CPUs 4 to 7, an input and an output of data between the main memory 2 and the L1 cache 11 or the L2 cache 12. For example, the routing controller 13 sends, to the cache control device 14, a load request received from the CPU 4. Then, the routing controller 13 receives, from the cache control device 14, a response to the load request. Furthermore, the routing controller 13 sends a store request received from the CPU 4 to the cache control device 14.

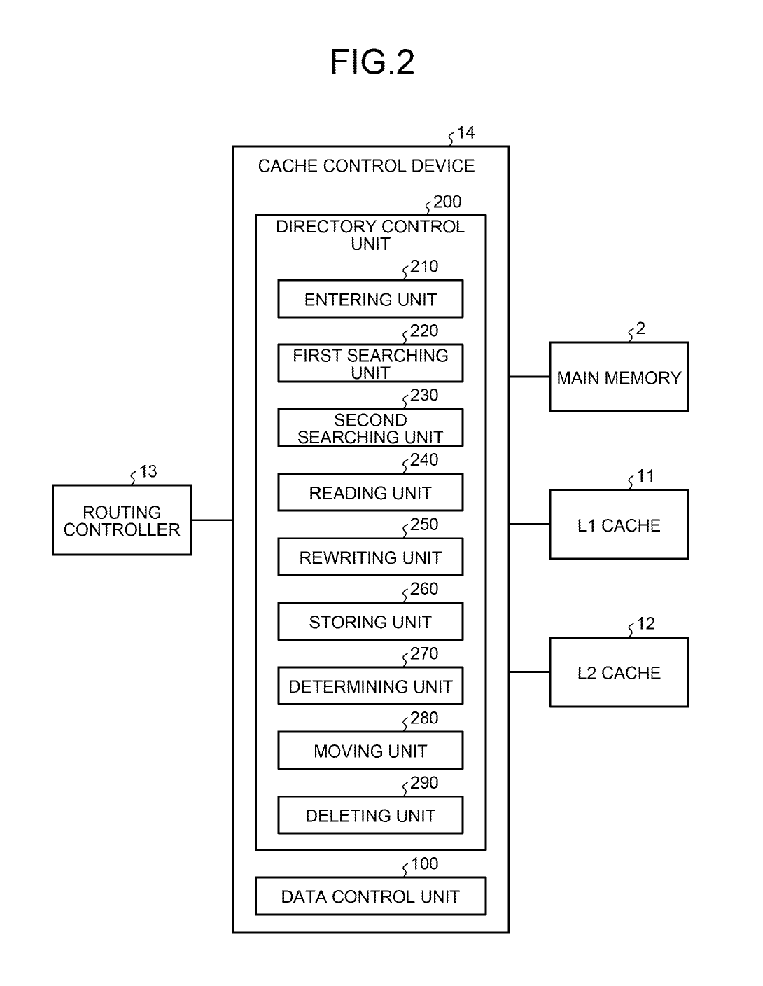

The cache control device 14 controls the reading and the writing of data or a directory received from the routing controller 13. In the following, the configuration of the cache control device 14 will be described with reference to FIG. 2.

FIG. 2 is a block diagram illustrating the configuration of the cache control device. As illustrated in FIG. 2, the cache control device 14 includes a data control unit 100 and a directory control unit 200.

The data control unit 100 controls the reading and the writing of data received from the routing controller 13. For example, the data control unit 100 reads, from the L1 cache 11, the data received from the routing controller 13. Then, the data control unit 100 outputs the read data to the routing controller 13.

The directory control unit 200 controls the reading and the writing of a directory received from the routing controller 13. The directory control unit 200 includes an entering unit 210, a first searching unit 220, a second searching unit 230, a reading unit 240, a rewriting unit 250, a storing unit 260, a determining unit 270, a moving unit 280, and a deleting unit 290.

The entering unit 210 determines whether a request received from the routing controller 13 is a load request or a store request. Then, the entering unit 210 alternately enters, into pipelines, a load request for the reading of a directory received from the routing controller 13 and a store request for rewriting the directory. For example, the entering unit 210 enters a load request into a pipeline in a read cycle of the L1 cache 11 and the L2 cache 12 and enters a store request into a pipeline in a write cycle.

Specifically, if the entering unit 210 receives requests in the order of a store request, a load request, and a load request, the entering unit 210 enters the store request into a pipeline in a write cycle and then enters the load request into a pipeline in a read cycle. Then, in the next write cycle, the entering unit 210 does not perform any process and then enters the load request into a pipeline in the next read cycle. In other words, the entering unit 210 performs a pipeline process, outputs the received load request to the first searching unit 220, and outputs the received store request to the second searching unit 230.

Furthermore, when the second searching unit 230 determines that the directory targeted by the store request is not present in the L1 cache 11, the entering unit 210 re-enters the store request into a pipeline as a load request.

Furthermore, the entering unit 210 re-enters, in a pipeline in the following case, a store request for a directory, which is determined as not being present in the L1 cache 11 by the second searching unit 230. Namely, after the storing unit 260 stores the received directory in the L1 cache 11, the entering unit 210 re-enters the store request into a pipeline.

The first searching unit 220 receives a load request for a directory that was entered by the entering unit 210, searches the L1 cache 11 and the L2 cache 12, and then determines whether a received directory is present.

When it is determined that the received directory is present in the L1 cache 11, the first searching unit 220 notifies the reading unit 240 that the received directory is present in the L1 cache 11.

Furthermore, if it is determined that the received directory is not present in the L1 cache 11 but is present in the L2 cache 12, the first searching unit 220 notifies the reading unit 240 that the received directory is present in the L2 cache 12.

Furthermore, if it is determined that the received directory is not present in the L2 cache 12, the first searching unit 220 notifies the reading unit 240 that the received directory is not present in the L1 cache 11 nor the L2 cache 12.

Furthermore, the first searching unit 220 receives the load request that is re-entered by the entering unit 210 and then determines whether the received directory is present by searching the L2 cache 12. If it is determined that the received directory is present in the L2 cache 12, the first searching unit 220 notifies the reading unit 240 that the received directory is present in the L2 cache 12.

Furthermore, if it is determined that the received directory is not present in the L1 cache 11, the first searching unit 220 notifies both the storing unit 260 and the determining unit 270 that the received directory is not present in the L1 cache 11.

The second searching unit 230 receives a store request for a directory entered by the entering unit 210, searches the L1 cache 11, and determines whether the received directory is present. When it is determined that the received directory is present in the L1 cache 11, the second searching unit 230 notifies the rewriting unit 250 that the received directory is present in the L1 cache 11.

When it is determined that the received directory is not present in the L1 cache 11, the second searching unit 230 notifies both the entering unit 210 and the storing unit 260 that the received directory is not present in the L1 cache 11.

Furthermore, the second searching unit 230 receives a store request that has been re-entered by the entering unit 210, searches the L1 cache 11, and then determines whether the received directory is present. When it is determined that the received directory is present in the L1 cache 11, the second searching unit 230 notifies the rewriting unit 250 that the received directory is present in the L1 cache 11.

When the reading unit 240 receives a notification from the first searching unit 220 indicating that the received directory is present in the L1 cache 11 or the L2 cache 12, the reading unit 240 reads the directory. Then, the reading unit 240 outputs, to the routing controller 13, the directory that has been read from the L1 cache 11 or the L2 cache 12.

Furthermore, when the reading unit 240 receives a notification from the first searching unit 220 indicating that the received directory is not present in the L1 cache 11 nor the L2 cache 12, the reading unit 240 reads the received directory from the main memory 2.

When the rewriting unit 250 receives a notification from the second searching unit 230 indicating that the received directory is present in the L1 cache, the rewriting unit 250 rewrites the directory that is present in the L1 cache 11.

When the storing unit 260 receives, from the first searching unit 220 or the second searching unit 230, a notification indicating that the received directory is not present in the L1 cache 11, the storing unit 260 stores the directory that has been read by the reading unit 240 in the L1 cache 11. For example, the storing unit 260 stores, in the L1 cache 11, the directory that has been read by the reading unit 240 from the L2 cache 12 or the main memory 2.

However, when the storing unit 260 receives the notification described below, the storing unit 260 stores, in the L1 cache 11, the directory that has been read by the reading unit 240. For example, when the storing unit 260 receives, from the determining unit 270, a notification that a free entry is present in the L1 cache 11, the storing unit 260 stores the directory in the L1 cache 11. Furthermore, when the storing unit 260 receives, from the moving unit 280, a notification indicating that a selected entry has been moved from the L1 cache 11 to the L2 cache 12, the storing unit 260 stores the directory in the L1 cache 11.

In such a case, the storing unit 260 notifies both the entering unit 210 and the deleting unit 290 that the directory, which has been read from the L2 cache 12 or the main memory 2 by the reading unit 240, is stored in the L1 cache 11.

When the determining unit 270 receives a notification from the first searching unit 220 indicating that the directory is not present in the L1 cache 11, the determining unit 270 determines whether a free entry is present in the L1 cache 11. When it is determined that no free entry is present in the L1 cache 11, the determining unit 270 notifies the moving unit 280 that no free entry is present in the L1 cache 11. In contrast, when it is determined that a free entry is present in the L1 cache 11, the determining unit 270 notifies the storing unit 260 that a free entry is present in the L1 cache 11.

When the moving unit 280 receives a notification from the determining unit 270 that no free entry is present in the L1 cache 11, the moving unit 280 selects an entry by using, for example, a least recently used (LRU) algorithm. Then, the moving unit 280 moves the selected entry from the L1 cache 11 to the L2 cache 12. Specifically, the moving unit 280 replaces the selected entry from the L1 cache 11 to the L2 cache 12. At this point, the moving unit 280 moves the entry to the L2 cache 12 only in a write cycle. Because this write cycle is dedicated to replacement, the subsequent load request or store request is not blocked.

Furthermore, the moving unit 280 notifies the storing unit 260 that the selected entry is moved from the L1 cache 11 to the L2 cache 12.

When a directory that is read from the L2 cache 12 by the reading unit 240 is stored in the L1 cache 11 by the storing unit 260, the deleting unit 290 deletes the directory stored in the L2 cache 12.

A description will be given here by referring back to FIG. 1. The node controller 20 is a control device that controls, in accordance with requests from the CPUs 6 and 7, an input and an output of data between the main memory 3 and an L1 cache 21 or an L2 cache 22. The node controller 20 includes the L1 cache 21, the L2 cache 22, a routing controller 23, and a cache control device 24. The configuration of the L1 cache 21 is the same as that of the L1 cache 11. The configuration of the L2 cache 22 is the same as that of the L2 cache 12. The configuration of the routing controller 23 is the same as that of the routing controller 13. The configuration of the cache control device 24 is the same as that of the cache control device 14.

Operation of a process performed by the cache control device according to the first embodiment

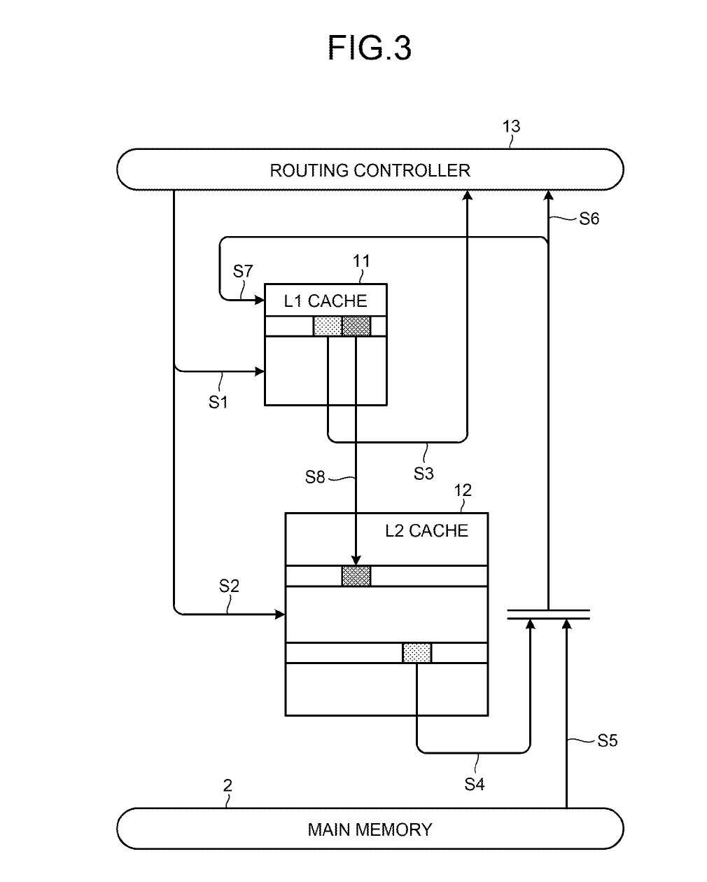

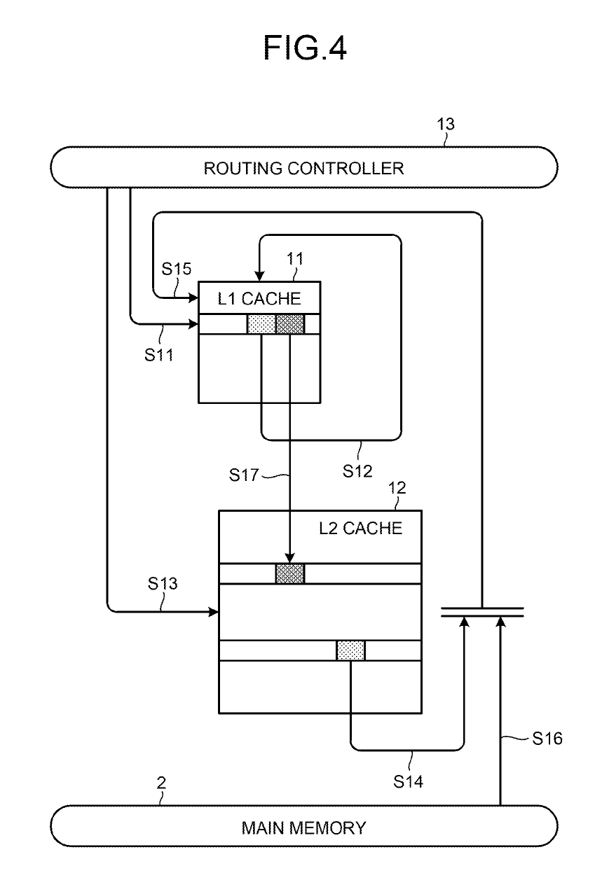

In the following, the operation of a process performed by the cache control device 14 according to the first embodiment will be described with reference to FIGS. 3 and 4. First, the operation of a process performed by the cache control device 14 when a load request is received will be described with reference to FIG. 3. Then, the operation of a process performed by the cache control device 14 when a store request is received will be described with reference to FIG. 4.

Load Request

FIG. 3 is a schematic diagram illustrating the operation of a process performed by the cache control device when a load request is received. As illustrated in FIG. 3, when the cache control device 14 receives a load request for a directory from the routing controller 13, the cache control device 14 searches the L1 cache 11 and determines whether a target directory is present (Step S1). Furthermore, the cache control device 14 searches the L2 cache 12 almost at about the same time when the cache control device 14 searches the L1 cache 11 and then determines whether the target directory is present (Step S2).

When it is determined that the target directory is present in the L1 cache 11, the cache control device 14 reads the target directory and outputs the directory to the routing controller 13 (Step S3).

In contrast, when it is determined that the target directory is not present in the L1 cache 11 but is present in the L2 cache 12, the cache control device 14 performs the following process. Namely, the cache control device 14 reads the directory from the L2 cache (Step S4) and then outputs the directory to the routing controller 13 (Step S6). At this point, when it is determined that the target directory is not also present in the L2 cache 12, the cache control device 14 reads a directory from the main memory 2 (Step S5) and then outputs the directory to the routing controller 13 (Step S6).

Then, the cache control device 14 stores, in the L1 cache 11, the directory that was read from the L2 cache 12 or the main memory 2 (Step S7). At this point, when it is determined that no free entry is present in the L1 cache 11, the cache control device 14 moves the entry that has been selected by using, for example, the LRU algorithm, to the L2 cache 12 (Step S8).

Store Request

FIG. 4 is a schematic diagram illustrating the operation of a process performed by the cache control device when a store request is received. As illustrated in FIG. 4, when the cache control device 14 receives a store request for a directory from the routing controller 13, the cache control device 14 searches the L1 cache 11 and then determines whether a target directory is present (Step S11). At this point, when it is determined that the target directory is present in the L1 cache 11, the cache control device 14 reads the target directory (Step S12) and then updates the directory (Step S13).

In contrast, when it is determined that the target directory is not present in the L1 cache 11, the cache control device 14 searches the L2 cache 12 for a target directory as a load request (Step S14). When it is determined that the target directory is present in the L2 cache 12, the cache control device 14 reads the target directory and then stores the directory in the L1 cache (Step S15). At this point, when it is determined that the target directory is not also present in the L2 cache 12, the cache control device 14 reads a directory from the main memory 2 (Step S16) and then stores the directory in the L1 cache 11 (Step S15).

Furthermore, when the directory that has been read from the L2 cache 12 or the main memory 2 is stored in the L1 cache 11 and when it is determined that no free entry is present in the L1 cache 11, the cache control device 14 performs the following process. Namely, the cache control device 14 moves the entry that has been selected by using, for example, the LRU algorithm to the L2 cache 12 (Step S17).

Flow of a process performed by the cache control device according to the first embodiment

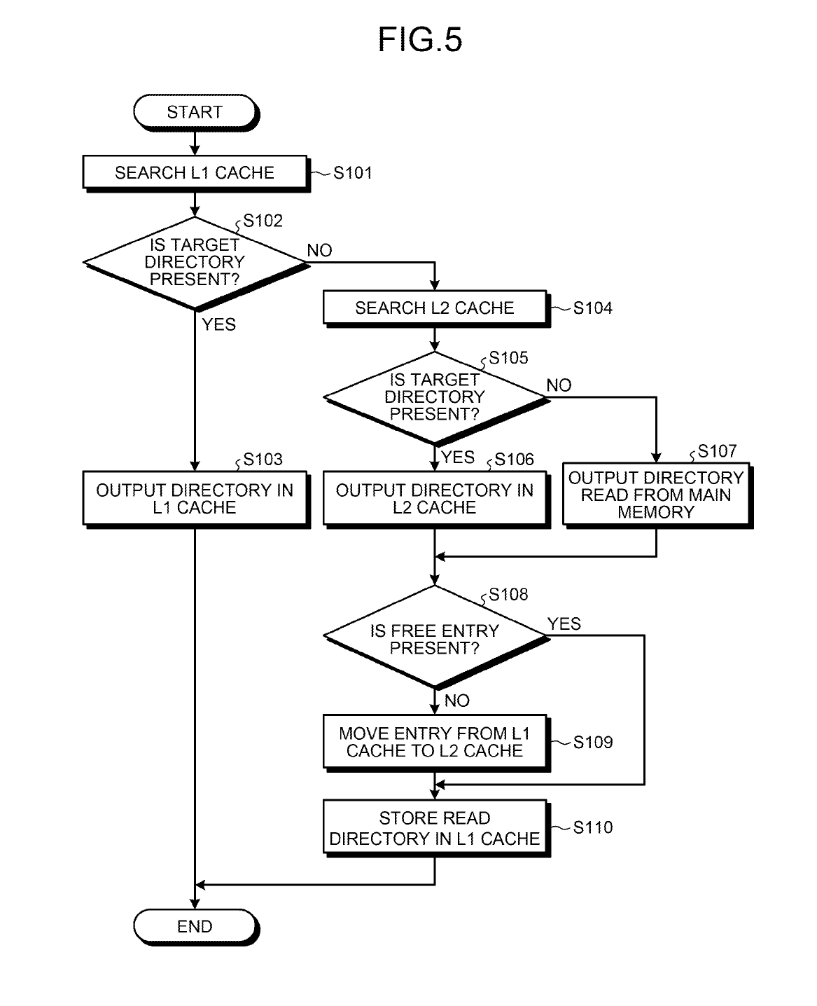

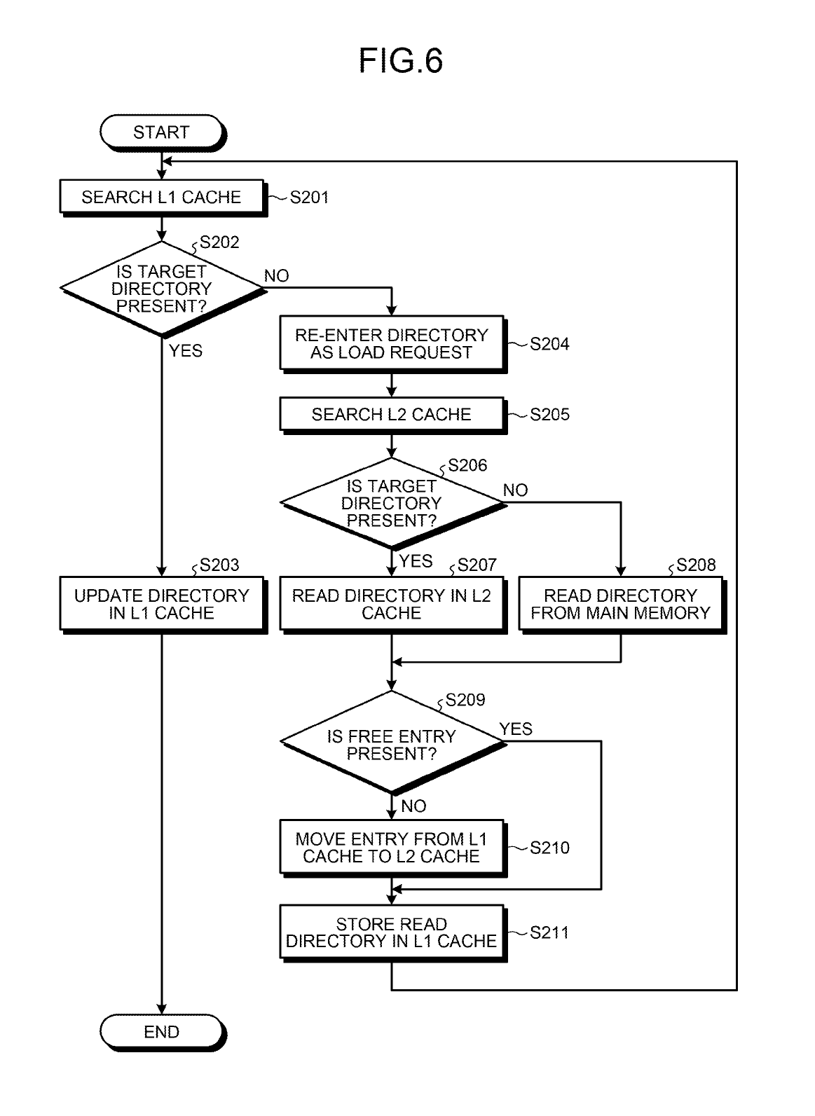

In the following, the flow of a process performed by the cache control device 14 according to the first embodiment will be described with reference to FIGS. 5 and 6. First, the flow of a process performed by the cache control device 14 when a load request is received will be described with reference to FIG. 5. Then, the flow of a process performed by the cache control device when a store request is received will be described with reference to FIG. 6.

Load Request Process

FIG. 5 is a flowchart illustrating the flow of a process performed by the cache control device when a load request is received. For example, the cache control device 14 performs the following process triggered when a load request is received from the routing controller 13.

As illustrated in FIG. 5, the cache control device 14 searches the L1 cache 11 (Step S101) and then determines whether a target directory is present (Step S102). At this point, when it is determined that the target directory is present in the L1 cache 11 (Yes at Step S102), the cache control device 14 performs the following process. Namely, the cache control device 14 reads the directory in the L1 cache 11, outputs the directory to the routing controller 13 (Step S103), and then ends the process.

In contrast, when it is determined that the target directory is not present in the L1 cache 11 (No at Step S102), the cache control device 14 searches the L2 cache 12 (Step S104). Then, the cache control device 14 determines whether the target directory is present in the L2 cache 12 (Step S105).

At this point, when it is determined that the target directory is present in the L2 cache 12 (Yes at Step S105), the cache control device 14 reads the target directory and then outputs the directory to the routing controller 13 (Step S106). In contrast, when it is determined that the target directory is not present in the L2 cache 12 (No at Step S105), the cache control device 14 reads the target directory from the main memory 2 and then outputs the directory to the routing controller 13 (Step S107).

Subsequently, the cache control device 14 determines whether a free entry is present in the L1 cache 11 (Step S108). At this point, when it is determined that no free entry is present in the L1 cache (No at Step S108), the cache control device 14 moves the selected entry from the L1 cache to the L2 cache 12 (Step S109) and then proceeds to Step S110. In contrast, when it is determined that a free entry is present in the L1 cache 11 (Yes at Step S108), the cache control device 14 proceeds to Step S110.

The cache control device 14 stores the read directory in the L1 cache 11 (Step S110) and then ends the process.

Store Request Process

FIG. 6 is a flowchart illustrating the flow of a process performed by the cache control device when a store request is received. For example, the cache control device 14 performs the following process triggered when a store request is received from the routing controller 13.

As illustrated in FIG. 6, the cache control device 14 searches the L1 cache 11 (Step S201) and determines whether a target directory is present (Step S202). At this point, when it is determined that the target directory is present in the L1 cache 11 (Yes at Step S202), the cache control device 14 performs the following process. Namely, the cache control device 14 reads the directory in the L1 cache 11, updates the read directory (Step S203), and then ends the process.

In contrast, when it is determined that the target directory is not present in the L1 cache 11 (No at Step S202), the cache control device 14 re-enters the directory as a load request (Step S204) and searches the L2 cache 12 (Step S205). Then, the cache control device 14 determines whether the target directory is present in the L2 cache 12 (Step S206).

At this point, when it is determined that the target directory is present in the L2 cache 12 (Yes at Step S206), the cache control device 14 reads the target directory (Step S207). In contrast, when it is determined that the target directory is not present in the L2 cache 12 (No at Step S206), the cache control device 14 reads the target directory from the main memory (Step S208).

Subsequently, the cache control device 14 determines whether a free entry is present in the L1 cache 11 (Step S209). At this point, when it is determined that a free entry is not present in the L1 cache 11 (No at Step S209), the cache control device 14 moves the selected entry from the L1 cache 11 to the L2 cache 12 (Step S210) and then proceeds to Step S211. In contrast, when it is determined a free entry is present in the L1 cache 11 (Yes Step S209), the cache control device 14 proceeds to Step S211.

The cache control device 14 stores the read directory in the L1 cache 11 (Step S211), returns to Step S201, and re-enters a store request.

Advantage of the cache control device according to the first embodiment

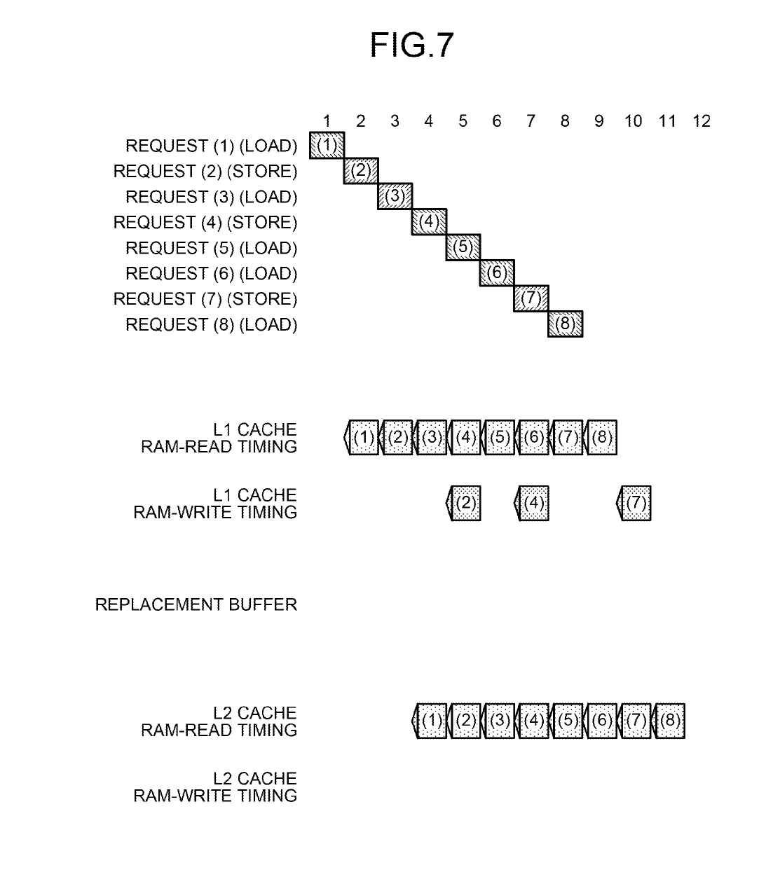

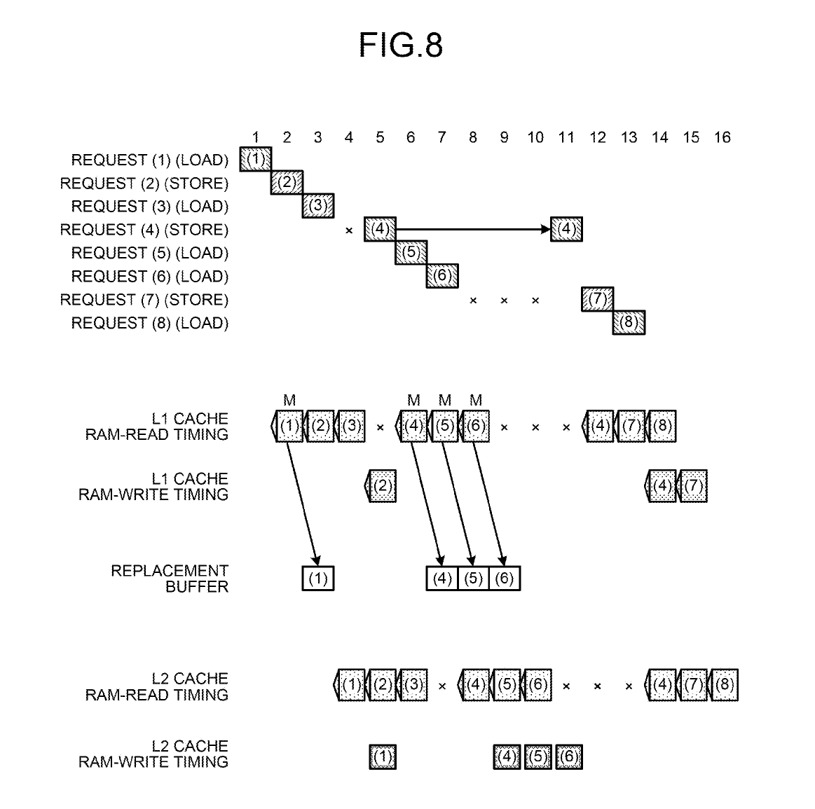

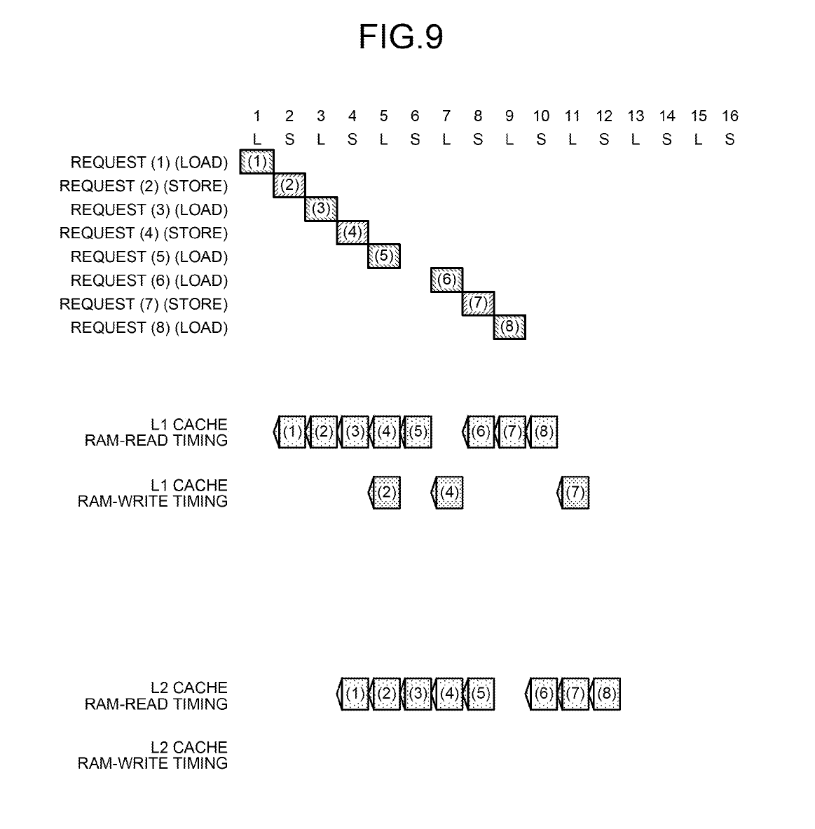

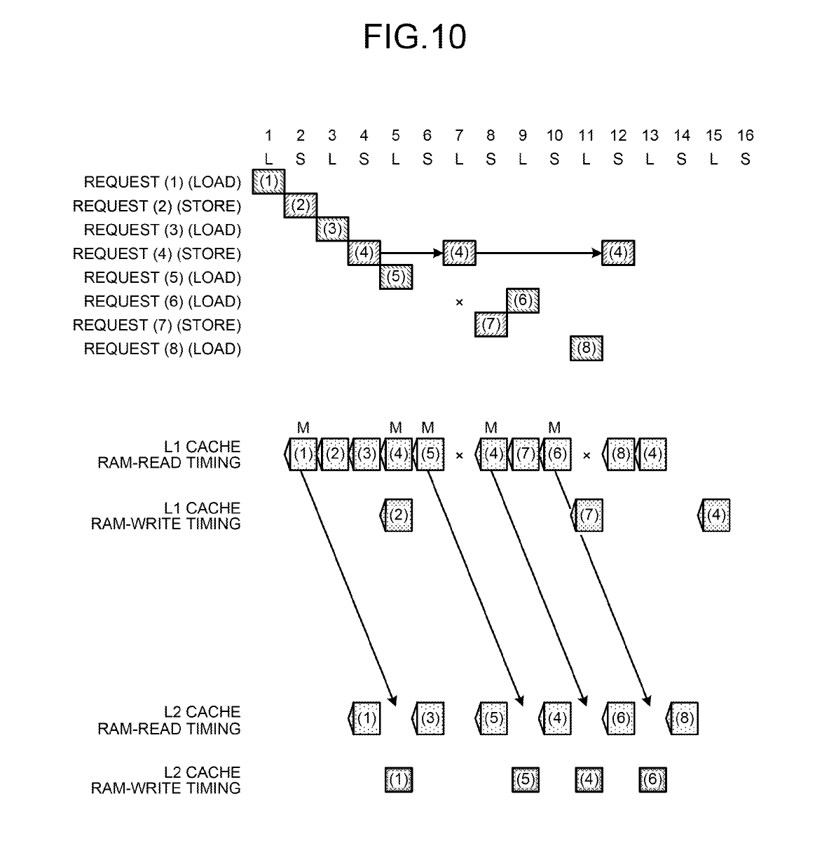

In the following, an advantage of the cache control device 14 according to the first embodiment will be described with reference to FIGS. 7 to 10. First, the timing at which data is entered into a pipeline performed by a cache control device according to a related technology will be described with reference to FIGS. 7 and 8. Then, the timing at which the cache control device 14 according to the first embodiment enters data into a pipeline will be described with reference to FIGS. 9 and 10.

FIG. 7 is a timing chart illustrating a state in which requests are entered into pipelines performed by the cache control device according to a related technology. As illustrated in FIG. 7, the cache control device according to the related technology receives five load requests and three store requests in the order of a load request, a store request, a load request, a store request, a load request, a load request, a store request, and a load request. At this point, the cache control device according to the related technology enters, into pipelines, the requests that are received between cycle 1 and cycle 8.

In the following, a description will be given of the time at which a cache miss occurs in the cache control device according to the related technology when the cache control device receives a load request and a store request. FIG. 8 is another timing chart illustrating a state in which requests are entered into pipelines performed by a cache control device according to the related technology. A description will be given with the assumption that five load requests and three store requests are received; with the assumption that, from among these requests, a cache miss occurs, in the L1 cache, three times when the load requests are received and a cache miss occurs, in the L1 cache, once when the store request is received; and with the assumption that the replacement is performed on all of the directories.

For example, as illustrated in FIG. 8, at the read timing in the L1 cache, a cache miss occurs in the first request received, which is a load request; the fourth request received, which is a store request; the fifth request received, which is a load request; and the sixth request received, which is a load request.

The cache control device according to the related technology performs the replacement by moving, to the L2 cache, the directories targeted by the first request received, which is a load request; the fourth request received, which is a store request; the fifth request received, which is a load request; and the sixth request received, which is a load request in order to write the directories into the L1 cache. Consequently, in cycle 4, cycle 8, cycle 9, and cycle 10, the cache control device according to the related technology is not able to enter the requests into the pipelines.

FIG. 9 is a timing chart illustrating a state in which requests are entered into pipelines performed by the cache control device 14 according to the first embodiment. As illustrated in FIG. 9, the cache control device 14 according to the first embodiment receives five load requests and three store requests in the order of a load request, a store request, a load request, a store request, a load request, a load request, a store request, and a load request. At this point, after the cache control device 14 according to the first embodiment received the fifth request, which is a load request, the cache control device 14 consecutively receives the sixth request, which is a load request. Therefore, the cache control device 14 enters the sixth request, which is a load request, into a pipeline by shifting the timing by one cycle. Consequently, the cache control device 14 according to the first embodiment enters, into pipelines, the requests that are received between cycle 1 and cycle 9.

FIG. 10 is another timing chart illustrating a state in which requests are entered into pipelines performed by the cache control device 14 according to the first embodiment. A description will be given with the assumption that the cache control device 14 receives five load requests and three store requests; with the assumption that, from among the received requests, a cache miss occurs, in the L2 cache, three times when the load requests are received and a cache miss occurs, in the L2 cache, once when the store request is received; and with the assumption that the replacement is performed on all of the directories.

For example, as illustrated in FIG. 10, at the Read timing in the L1 cache, a cache miss occurs in the first request received, which is a load request; the fourth request received, which is a store request; the fifth request received, which is a load request; and the sixth request received, which is a load request.

The cache control device 14 according to the first embodiment performs the replacement by moving, to the L2 cache, the directories targeted by the first request received, which is a load request; the fourth request received, which is a store request; the fifth request received, which is a load request; and the sixth request received, which is a load request in order to write the directories into the L1 cache. At this point, because the cache control device 14 according to the first embodiment alternately enters a load request and a store request into the pipelines and performs the replacement at the Write timing of the L2 cache, the cache control device 14 can perform the subsequent processes on the load requests and the store requests without blocking them. Furthermore, because a cache miss occurs in the fourth request received, which is a store request, a delay occurs by the cycles corresponding to a cycle in which a directory is re-entered as a load request and a cycle in which a directory is re-entered as a store request.

As described above, in both cases illustrated in FIGS. 8 and 10, five load requests and three store requests are received from among the load requests and the store requests that are entered into the pipelines. From among the received requests, a cache miss occurs, in the L1 cache, three times when the load requests are received and a cache miss occurs, in the L1 cache, once when the store request is received. The conditions are the same in which the replacement is performed on all of the directories.

When comparing the cache control device according to the related technology is compared with the cache control device 14 according to the first embodiment at the timing at which an eighth request is entered into a pipeline, in FIG. 8, the cycle in which the eighth request is entered is delayed by 5 cycles, i.e., between cycle 8 and cycle 13 illustrated in FIG. 7. This is because requests to be performed during 5 cycles are blocked due to four replacements and due to the re-entering of one store request.

In contrast, in FIG. 10, the cycle in which the eighth request is entered is delayed by 2 cycles, i.e., between cycle 9 and cycle 11 illustrated in FIG. 9. This delay in cycles is due to the blocking of re-entering of one load request and due to the re-entering of one store request caused by a cache miss due to the store request. Specifically, the cache control device 14 according to the first embodiment does not receive an effect of the replacement caused by a cache miss due to a load request. Furthermore, the cache control device 14 can reduce a delay in cycles by a maximum of 2 cycles that has occurred caused by a cache miss due to a store request.

As described above, even when the cache control device 14 performs a replacement, the cache control device 14 can perform a process without blocking a load request from entering into a pipeline. Consequently, the cache control device 14 can increase the throughput. Furthermore, as the frequency of the replacement is high and as the hit rate of the store requests is high, the cache control device 14 according to the first embodiment can increase the throughput compared with the cache control device according to the related technology.

Furthermore, due to the features of directories, the hit rate of the store requests is close to 100% almost regardless of the size of the high-speed cache memory. Furthermore, the frequency of the replacement becomes high as the size of the high-speed cache memory decreases. Specifically, the cache control device 14 according to the first embodiment can further increase the throughput compared with the cache control device according to the related technology and furthermore can reduce the latency.

### [b] Second Embodiment

The present invention can be implemented with various kinds of embodiments other than the embodiments described above. Therefore, another embodiment included in the present invention will be described below in a second embodiment.

System Configuration, etc.

Of the processes described in the embodiments, all or a part of the processes that are mentioned as being automatically performed can be manually performed, or all or a part of the processes that are mentioned as being manually performed can be automatically performed using known methods. Furthermore, the flow of the processes, the specific names, and the information containing various kinds of data or parameters indicated in the above specification and drawings can be arbitrarily changed unless otherwise stated.

Furthermore, the information stored in the storing unit illustrated in the drawings are only for examples and is not always stored as illustrated in the drawings.

Furthermore, the order of the processes performed at steps described in the embodiment may be changed depending on various loads or use conditions.

The components of each unit illustrated in the drawings are only for conceptually illustrating the functions thereof and are not always physically configured as illustrated in the drawings. For example, in the cache control device 14, the first searching unit 220 and the second searching unit 230 may be integrated.

According to an aspect of an embodiment of the present invention, an advantage is provided in that it is possible to suppress the reduction in throughput even when a replacement is performed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cache control device comprising:
an entering unit that alternately enters, into a pipeline, a load request for reading a directory that is received from a processor and a store request for rewriting a directory that is received from the processor;
a first searching unit that receives the load request that is entered by the entering unit, that searches a second cache memory and a first cache memory in which the speed of reading and writing data is higher than the speed of reading and writing data in the second cache memory, and that determines whether a directory targeted by the load request is present;
a reading unit that reads, when the first searching unit determines that the directory targeted by the load request is present in the first cache memory or the second cache memory, the directory from the cache memory in which the directory is present;
a second searching unit that receives the store request that is entered by the entering unit, that searches the first cache memory, and that determines whether a directory targeted by the store request is present; and
a rewriting unit that rewrites, when the second searching unit determines that the directory is present in the first cache memory, the directory in the first cache memory.

2. The cache control device according to claim 1, wherein
when the second searching unit determines that the directory targeted by the store request is not present in the first cache memory, the entering unit re-enters the store request as a load request into a pipeline, and
the first searching unit receives the load request that is re-entered by the entering unit, searches the second cache memory, and determines whether a directory targeted by the load request is present.

3. The cache control device according to claim 1, wherein, when the first searching unit determines that the directory is not present in the first cache memory nor the second cache memory, the reading unit reads a directory targeted by the load request from a main memory.

4. The cache control device according to claim 3, further comprising a storing unit that stores, in the first cache memory when the first searching unit or the second searching unit determines that the directory is not present in the first cache memory, the directory read by the reading unit.

5. The cache control device according to claim 4, wherein, when the second searching unit determines that the directory targeted by the store request is not present in the first cache memory, the entering unit re-enters the store request into a pipeline after the storing unit stores the directory in the first cache memory.

6. The cache control device according to claim 1, further comprising:
a determining unit that determines, when the first searching unit determines that the directory is not present in the first cache memory, whether a free entry is present in the first cache memory; and
a moving unit that selects, when the determining unit determines that the free entry is not present in the first cache memory, an entry from the first cache memory and that moves the selected entry to the second cache memory.

7. The cache control device according to claim 6, further comprising a deleting unit that deletes, when the storing unit stores, in the first cache memory, the directory that was read from the second cache memory by the reading unit, the directory stored in the second cache memory.

8. A pipeline control method comprising:
entering, by a cache control device, alternately into a pipeline a load request for reading a directory that is received from a processor and a store request for rewriting a directory that is received from the processor; and
first determining, by the cache control device, when the load request is entered, whether a directory targeted by the load request is present by searching a second cache memory and a first cache memory in which the speed of reading and writing data is higher than the speed of reading and writing data in the second cache memory; and
reading, by the cache control device, the directory, when it is determined that the directory targeted by the load request is present; and
second determining, by the cache control device, when it is determined that the store request is entered, whether a directory targeted by the store request is present by searching the first cache memory; and
rewriting, by the cache control device, the directory when it is determined that the directory targeted by the store request is present in the first cache memory.

9. The pipeline control method according to claim 8, wherein
when it is determined that the directory targeted by the store request is not present in the first cache memory, the entering includes re-entering, the store request as a load request into a pipeline, and
the first determining includes receiving the load request that is re-entered at the re-entering, includes searching the second cache memory, and includes determining whether a directory targeted by the load request is present.

10. The pipeline control method according to claim 8, wherein, when it is determined that the directory targeted by the store request is not present in the first cache memory nor the second cache memory, the reading includes reading a directory targeted by the store request from a main memory.

11. The pipeline control method according to claim 10, further comprising storing, by the cache control device, the directory read at the reading in the first cache memory, when it is determined that the directory targeted by the load request or the directory targeted by the store request is not present in the first cache memory.

12. The pipeline control method according to claim 11, wherein, when it is determined that the directory targeted by the store request is not present in the first cache memory, the entering includes re-entering the store request into a pipeline after the directory is stored in the first cache memory at the storing.

13. The pipeline control method according to claim 8, further comprising:
third determining, by the cache control device, when it is determined the directory is not present in the first cache memory, whether a free entry is present in the first cache memory; and
selecting, by the cache control device, when it is determined that the free entry is not present in the first cache memory, an entry from the first cache memory; and
moving, by the cache control device, the selected entry to the second cache memory.

14. The pipeline control method according to claim 13, further comprising deleting, by the cache control device, when the directory that was read from the second cache memory is stored in the first cache memory, the directory stored in the second cache memory.
